(19) United States
(12) Patent Application Publication
(10) Pub. No.: US 2026/0334754 A1
(43) Pub. Date: Oct. 29, 2026

(54) DISHWASHER

(71) Applicant: LG ELECTRONICS INC., Seoul (KR)

(72) Inventor: Sang Ick JUNG, Seoul (KR)

(73) Assignee: LG ELECTRONICS INC., Seoul (KR)

(21) Appl. No.: 19/490,108

(22) PCT Filed: Jul. 19, 2024
(86) PCT No.: PCT/KR2024/010481

§ 371 Date: Dec. 4, 2025

(30) Foreign Application Priority Data
Aug. 1, 2023 (KR) 10-2023-0100321

(51) Int. Cl. A47L 15/42; A47L 15/22; G01J 1/42

(52) U.S. Cl. CPC A47L 15/4293; A47L 15/22; A47L 15/4259; A47L 15/4274; G01J 1/4204; A47L 2301/04; A47L 2401/20; A47L 2401/26; A47L 2501/265

(57) ABSTRACT

The present invention relates to a dishwasher that is configured to turn on an indicator only when a door is closed, so that when the door is opened and the bottom surface to which a visible light beam is irradiated is covered by the door, the indicator is turned off to prevent unnecessary power consumption, and is configured to apply an animation effect to a visual image displayed through the indicator when it is confirmed that a user is close to the dishwasher.

### TECHNICAL FIELD

The present invention relates to a dishwasher, and more specifically, to a dishwasher configured to turn on an indicator only when a door is in a closed state, so that when the door is opened and a floor surface to which a visible light beam is irradiated is covered by the door, the indicator is turned off to prevent unnecessary power consumption, and configured to apply an animation effect to a visual image displayed through the indicator when it is confirmed that a user is close to the dishwasher, so that the user can intuitively recognize whether the dishwasher is operating normally or whether the washing course is progressing normally.

### BACKGROUND ART

A dishwasher is a device which sprays washing water such as water to a wash target such as tableware, cooking utensils and the like accommodated therein to wash the wash target. At this time, the washing water used for washing the wash target may contain a detergent.

Ordinarily, the dishwasher is constructed by including a tub forming a washing space therein, a storage part accommodating the wash target in the tub, a spray arm spraying the washing water to the storage part, and a sump storing an amount of water therein and supplying the washing water to the spray arm.

By using this dishwasher, the time and effort required to wash tableware and other wash target after a meal can be reduced, contributing to user convenience.

Recently, the proportion of dishwashers disposed in a built-in manner is gradually increasing for the purpose of expanding the space for the kitchen.

In particular, more and more products have been recently released, which have a cover panel attached to the front surface of the doors so as to create a sense of unity with the space in which the dishwasher is disposed and the surrounding furniture.

The cover panel may be manufactured to have the same material texture and color as the exterior of the surrounding furniture in order to create a sense of unity with the surrounding furniture.

However, when the dishwasher is disposed in a built-in manner with the cover panel attached to the door in this way, the cover panel is in a state of covering the door generally.

As a result, the user has difficulty in intuitively determining whether the dishwasher is operating.

In this regard, European Patent Publication No. 3945978 (Related Document 001) discloses a dishwasher configured to irradiate a visible light beam toward an outside floor surface through an optical unit disposed in the door so as to allow the operating status of the dishwasher to be visually checked.

### DISCLOSURE

### Technical Problem

The optical unit provided in the dishwasher of the aforementioned Related Document 001 is configured so that the turned-on state of the optical unit is maintained regardless of whether the door is open.

As a result, even when the floor surface on which the visible light beam is irradiated is covered by the door at the time of the opening of the dishwasher door, the turned-on state of the optical unit is maintained, resulting in the problem of unnecessary power consumption.

Besides, the optical unit provided in the dishwasher of Related Document 001 is configured so that the turned-on state of the optical unit can be continuously maintained even in a standby state in which the dishwasher is not actually operating.

Thus, even when the user is aware that the dishwasher is in a state capable of normal operation or in a standby state, the optical unit is needlessly maintained in the turned-on state, resulting in the problem of unnecessary power consumption.

Meanwhile, the optical unit provided in the dishwasher of the aforementioned Related Document 001 is configured so that the optical unit is maintained in the turned-on stated regardless of whether the user is in proximity.

Therefore, there is a problem in that it is difficult to intuitively recognize whether the dishwasher is operating normally or whether the washing course is progressing normally, only through the visible light beam displayed by the optical unit during operation of the dishwasher or during progress of the washing course.

Due to this, there is a problem in that, in order for the user to check whether the dishwasher is operating normally or whether the washing course is progressing normally, an additional confirmation procedure, such as visually checking the display of the door, is required, which may cause inconvenience to the user.

The present invention has been conceived to solve the problems of the related art as described above, and the first object thereof is to provide a dishwasher and a control method thereof, which are configured to turn on the indicator only when the door of the dishwasher is in a closed state, so that the indicator is turned off when the floor surface on which the visible light beam is irradiated becomes covered by the door at the time of the opening of the door, thereby preventing unnecessary power consumption.

Additionally, the second object of the present invention is to provide a dishwasher and a control method thereof, which are configured to turn on the indicator for only a predetermined time to allow the user to recognize that the dishwasher is in a state capable of normal operation or in a standby state, and then turn it off, thereby limiting the turn-on time of the indicator to a minimum to minimize power consumption.

Further, the third object of the present invention is to provide a dishwasher and a control method thereof, which are configured to apply an animation effect to the visual image displayed through the indicator when it is confirmed that the user is in proximity to the dishwasher, so that the user can intuitively recognize whether the dishwasher is operating normally or whether the washing course is progressing normally.

Additionally, the fourth object of the present invention is to provide a dishwasher and a control method thereof, which are configured so that, when it is confirmed that the user is not in proximity to the dishwasher, an animation effect is not applied, thereby minimizing power consumption.

The purposes of the present invention are not limited to the purposes mentioned above, and other unmentioned purposes and advantages of the present invention can be understood from the following description and will be more clearly understood through the embodiments of the present invention. Furthermore, it will be readily understood that the purposes and advantages of the present invention can be achieved by the means and combinations thereof set forth in the claims.

### Technical Solution

A dishwasher according to the present invention is characterized by including a tub inside which a washing space is formed; a door opening or closing an open front side of the tub; an indicator projecting a visible light beam onto an outside floor surface to display predetermined information as a visual image; and a control part controlling operation of the indicator based on whether the door is in a closed state or an opened state, or based on whether a user is present within a predetermined set distance range.

Also, the control part may perform a step of making decision on whether to operate the indicator based on whether the door is in a closed state or an opened state.

Also, the dishwasher may further include a door position sensor sensing whether the door is in a closed state, wherein the step of making decision on whether to operate the indicator may include: a step of receiving an output signal from the door position sensor; a step of determining, from the output signal received from the door position sensor, whether the door is in a closed state; and a step of turning on the indicator by supplying power to the indicator when a decision is made that the door is in a closed state in the step of determining whether the door is in a closed state.

Also, the dishwasher may further include an input part into which a user's operation for turning power on and off, a user's operation for selecting a washing course, and a user's operation for starting a course are input, wherein the control part may further perform a step of receiving the operation for turning power on, which is input through the input part, before the step of receiving an output signal from the door position sensor.

Also, the control part may further perform a step of determining whether the operation for selecting a washing course, and the operation for starting a course are input, before the step of turning on the indicator, when a decision is made that the door is in a closed state in the step of determining whether the door is in a closed state.

Also, in the step of turning on the indicator, the indicator may display visual information corresponding to the selected washing course.

Also, the dishwasher may further include an optical sensor disposed in the door and sensing external illumination, wherein the step of turning on the indicator may include: a step of receiving an output signal from the optical sensor; a step of comparing the external illumination sensed from the output signal received from the optical sensor with a preset reference illumination; and a step of supplying, to the indicator, an adjusted power lower than a basic power when it is determined that the external illumination is less than the reference illumination.

Also, the step of turning on the indicator may further include a step of supplying the basic power to the indicator when it is determined that the external illumination is greater than or equal to the reference illumination.

Also, the control part may further perform a step of, before the step of making decision on whether to operate the indicator, turning on the indicator regardless of whether the door is in an opened state or in a closed state when power is applied from an external power supply for a first time after connection to an external power supply has been cut off.

Also, the control part may further perform a step of comparing an elapsed time from after the power is first supplied from an external power supply with a predetermined set time; and a step of turning off the indicator by cutting off the power supplied to the indicator when it is determined that the elapsed time has reached the predetermined set time in the step of comparing an elapsed time with a predetermined set time.

Also, the predetermined set time may be within a range between 4 seconds and 6 seconds.

Also, the control part may perform a step of driving the indicator in a normal mode or in a proximity mode based on whether a user is present within a predetermined set distance range from the door.

Also, the dishwasher may further include an optical sensor disposed in the door and sensing whether a user is present within the set distance range, wherein the step of driving the indicator in a normal mode or in a proximity mode may include: a step of receiving an output signal from the optical sensor; and a step of determining, based on the output signal received from the optical sensor, whether a user is present within the set distance range.

Also, the set distance range may be a distance of 0.9 meters or more and 1.1 meters or less.

Also, the step of driving the indicator in a normal mode or in a proximity mode may further include a step of driving the indicator in the proximity mode when it is determined that a user is present within the set distance range in the step of determining whether a user is present within the set distance range.

Also, the step of driving the indicator in a normal mode or in a proximity mode may further include a step of driving the indicator in the normal mode when it is determined that a user is not present within the set distance range in the step of determining whether a user is present within the set distance range.

Also, the driving according to the normal mode may be a driving to change the visual image in response to a progress status of a washing course to be progressed in the washing space, and the driving according to the proximity mode may be a driving to change the visual image by additionally applying an animation effect to the driving according to the normal mode.

Also, the animation effect may include a brightness variation region movement effect, in which a portion of a display region where the visual image is displayed is set as a brightness variation region so as to have a lower or higher brightness than a remaining region, and the brightness variation region is moved.

Also, the visual image may include a letter image, and the animation effect may include a letter movement effect, in which letters of a sentence forming the letter image are moved in a unit of a letter at a predetermined time interval.

Also, the predetermined set interval may be within a range from 0.3 seconds to 0.6 seconds.

Also, by the letter movement effect, the letters may be moved toward the left direction.

### Advantageous Effects

The dishwasher and the control method thereof according to the present invention have an effect of preventing unnecessary power consumption because they are configured to turn on the indicator only when the door of the dishwasher is in a closed state.

Additionally, the dishwasher and the control method thereof according to the present invention have an effect of limiting the turn-on time of the indicator to a minimum to minimize the power consumption because they are configured to turn on the indicator for only a predetermined time to allow the user to recognize that the dishwasher is in a state capable of normal operation or in a standby state, and then turn it off.

Also, the dishwasher and the control method thereof according to the present invention have an effect of being able to further reduce power consumption because they are configured to adjust the illumination of the visible light beam irradiated by the indicator according to the ambient illumination around the dishwasher.

Also, the dishwasher and the control method thereof according to the present invention have an effect of being able to improve the user's visibility because they apply an animation effect to the visual image displayed through the indicator when it is recognized that the user is in proximity to the dishwasher.

Specific effects of the present invention, including the effects described above, will be described below together with specific matters for practicing the invention.

### DESCRIPTION OF DRAWINGS

FIG. 1 is a front perspective view of a dishwasher according to an embodiment of the present invention.

FIG. 2 is a schematic cross-sectional view of the dishwasher illustrated in FIG. 1.

FIGS. 3A and 3B are a schematic view and a partially enlarged view for explaining a state in which the visual image displayed through the indicator is perceived by a user.

FIG. 4 illustrates examples of the visual image displayed on the outside floor surface through the indicator of FIG. 3.

FIGS. 5 and 6 illustrate examples of animation effects added to a visual image.

FIG. 7 is a schematic cross-sectional view of the indicator provided in the dishwasher according to an embodiment of the present invention.

FIG. 8 is a functional block diagram for explaining the configuration of the control part of the dishwasher according to an embodiment of the present invention.

FIGS. 9 to 14 are flowcharts for explaining a control method of the dishwasher according to an embodiment of the present invention.

### BEST MODEL

The above-mentioned purposes, features and advantages will now be described in detail below with reference to the accompanying drawings, so that a person having ordinary knowledge in the technical field to which the present invention pertains can easily practice the technical idea of the present invention. In describing the present invention, if it is determined that a detailed description of a known technology related to the present invention may unnecessarily obscure the gist of the present invention, the detailed description thereof will be omitted. Hereinafter, preferred embodiments according to the present invention will be described in detail with reference to the accompanying drawings. In the drawings, like reference numerals are used to denote like or similar components.

Although the terms “first”, “second”, etc., may be used herein to describe various components, these components should not be limited by these terms. These terms are only used to distinguish one component from another component, and unless otherwise specifically stated, it is to be understood that a first component may of course be a second component.

Throughout the specification, unless otherwise specifically stated, each element may be singular or plural.

Hereinafter, the phrase “any element is disposed on (or below) a component” or “above (or under) a component” may mean not only that the element is disposed in contact with the top surface (or lower surface) of the component, but also that another element may be interposed between the component and the element disposed on (or below) the component.

Additionally, if a component is described as being “connected,” “coupled,” or “contacted” to another component, the components may be directly connected or contacted to one another, but it is to be understood that another element may be “interposed” between the components, or that the components may be “connected,” “coupled,” or “contacted” to each other through another element.

As used herein, singular expressions include plural expressions unless the context clearly indicates otherwise. In this application, the terms “comprise” or “include” should not be construed to necessarily include all the various components or various steps described in the specification, and should be construed to mean that some of the components or some of the steps may not be included, or that an additional component or step may be further included.

Additionally, singular expressions used herein include plural expressions unless the context clearly indicates otherwise. In this application, the terms “comprise” or “include” should not be construed to necessarily include all the various components or various steps described in the specification, and should be construed to mean that some of the components or some of the steps may not be included, or that an additional component or step may be further included.

Throughout the specification, in the case of using the phrase “A and/or B”, this means A, B, or A and B, unless otherwise specifically stated, and in the case of using the phrase “between C and D”, this means C or more and D or less, unless otherwise specifically stated.

### Overall Structure of Dishwasher

Hereinafter, the overall structure of a dishwasher 1 according to an embodiment of the present invention will be described in detail with reference to the accompanying drawings.

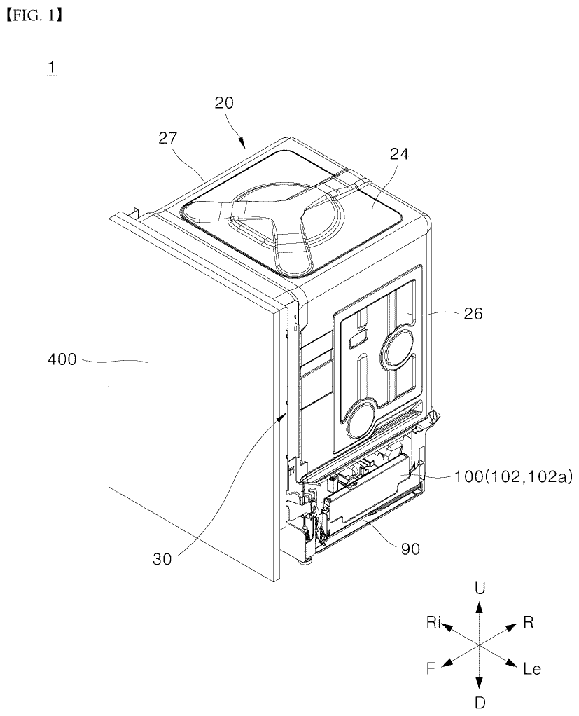

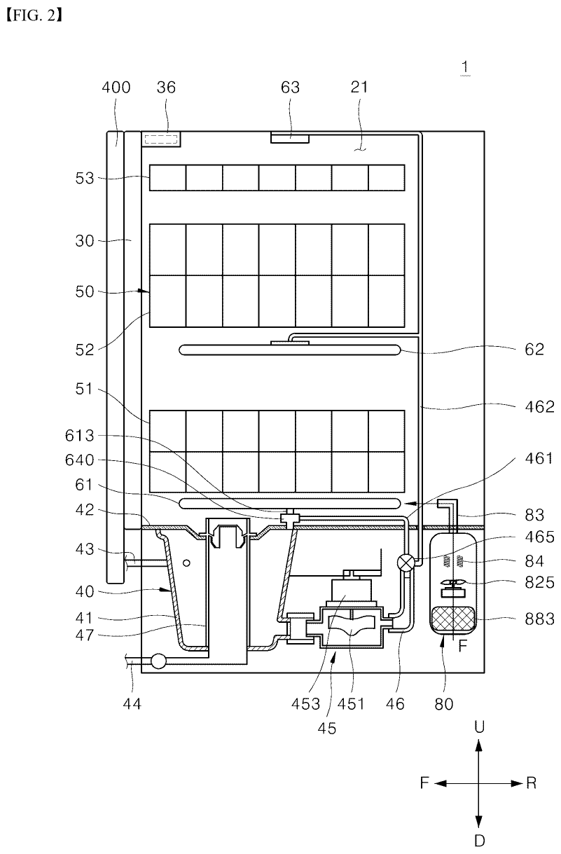

FIG. 1 is a front perspective view showing a dishwasher according to the present invention, FIG. 2 is a simplified cross-sectional view briefly showing the internal structure of a dishwasher according to the present invention.

In FIGS. 1 to 2, there is particularly shown the built-in type dishwasher 1 as the dishwasher 1 according to an embodiment of the present invention.

Because of being configured in a built-in type, the dishwasher 1 according to an embodiment of the present invention may not include a separate case covering the outer side of the tub 10. However, depending on the embodiment, it can also be configured to include a case (not shown) forming an outer body. Hereinafter, explanation will be made based on the dishwasher 1 shown in FIG. 1, but unless otherwise specified, the relationship between a door 30 and a cover panel 400 can also be applied to a dishwasher provided with a case.

Referring to FIGS. 1 and 2, the dishwasher 1 according to an embodiment of the present invention may be configured by including a tub 20 forming a washing space 21 in which wash targets are washed, and having an open front side, the door 30 for opening or closing the open front side of the tub 20, the cover panel 400 disposed in the front side of the door 30, a driving part 40 located in the lower side of the tub 20 to supply, collect, circulate, and discharge washing water for washing the wash targets, a storage part 50 detachably provided in the washing space 21 inside the tub 20, and on which the wash targets are placed, and a spray part installed adjacent to the storage part to spray washing water for washing the wash targets.

In this regard, examples of the wash targets placed in the storage part 50 may include tableware such as bowls, dishes, spoons, chopsticks and the like, and other cooking utensils. Unless otherwise stated below, the wash targets will be referred to as tableware.

The tub 20 may be formed in a box shape with the entire front side open, and corresponds to a configuration known as a so-called washing bath.

The washing space 21 can be formed inside the tub 20 whose open front side can be opened or closed by the door 30.

The tub 20 may be formed by pressing a metal plate that is resistant to high temperature and moisture, for example, a plate made of stainless steel series.

Also, as shown, in the case of an embodiment not including a separate case, the top surface 24, right side surface 27, left side surface 26, and rear surface of the tub 20 may be in a state of being exposed to the outside.

In addition, on the inner surface of the tub 20, there may be disposed a number of brackets for helping functional components such as the storage part 50, the spray part and the like to be described later to be supported and installed within the tub 20.

Meanwhile, the driving part 40 may be constructed by including a sump 41 storing the washing water, a sump cover 42 separating the sump 41 from the tub 20, a water supply part 43 supplying the washing water to the sump 41 from the outside, a drain part 44 discharging the washing water from the sump 41 to the outside, and a water supply pump 45 and a supply flow path 46 which supply the washing water from the sump 41 to the spray part.

The sump cover 42 is disposed on the upper side of the sump 41, and can serve to separate the tub 20 from the sump 41. In addition, the sump cover 42 may be provided with a plurality of recovery holes for recovering the washing water sprayed into the washing space 21 through the spray part into the sump 41.

That is, the washing water sprayed from the spray part toward the tableware may fall to the bottom of the washing space 21, and may be returned to the sump 41 through the sump cover 42.

The water supply pump 45 is provided in one side or lower side of the sump 41, and serves to pressurize the washing water to supply it to the spray part.

The water supply pump 45 may be connected at one end to the sump 41, and at the other end to the supply flow path 46. The water supply pump 45 may be provided with an impeller 451, a motor 453, and the like. When power is supplied to the motor 453, the impeller 451 rotates, and the washing water in the sump 41 can be pressurized and then supplied to the spray part through the supply flow path 46.

Meanwhile, the supply flow path 46 can serve to selectively supply to the spray part the washing water supplied from the water supply pump 45.

For example, the supply flow path 46 may include a first supply flow path 461 connected to a lower spray arm 61, and a second supply flow path 463 connected to an upper spray arm 62 and a top nozzle 63, and the supply flow path 46 may be provided with a supply flow path switching valve 465 that selectively opens or closes the supply flow paths 461, 463.

In this regard, the supply flow path switching valve 465 may be controlled so that each of the supply flow paths 461, 463 is opened sequentially or simultaneously.

Meanwhile, the spray part is provided to spray washing water on tableware and the like stored in the storage part 50.

More specifically, the spray part may include the lower spray arm 61 positioned in the lower portion of the tub 20 to spray the washing water to a lower rack 51, the upper spray arm 62 positioned between the lower rack 51 and an upper rack 52 to spray the washing water to the lower rack 51 and the upper rack 52, and the top nozzle 63 positioned in the upper portion of the tub 20 to spray the washing water to a top rack 53 or the upper rack 52.

Particularly, the lower spray arm 61 and the upper spray arm 62 may be rotatably provided in the washing space 21 of the tub 20 so that they can spray the washing water toward the tableware in the storage part 50 while rotating.

The lower spray arm 61 may be rotatably supported at the upper side of the sump cover 42 so that it can spray the washing water toward the lower rack 51 from the lower side of the lower rack 51 while rotating.

Additionally, the upper spray arm 62 may be rotatably supported by a spray arm holder (not shown) so that it can spray the washing water between the lower rack 51 and the upper rack 52 while rotating.

Meanwhile,, a means for diverting the washing water sprayed from the lower spray arm 61 to the up direction (U-direction) may be further provided at the lower surface 25 of the tub 20 to increase the washing efficiency.

Since the detailed configuration of the spray part can be embodied by applying a configuration already known in the art, a description of the specific configuration of the spray part is omitted below.

Meanwhile, the storage part 50 for storing the tableware may be provided in the washing space 21.

The storage part 50 is provided so as to be withdrawable from the inside of the tub 20 through the open front side of the tub 20.

For example, FIG. 2 shows an embodiment which provides the storage part including the lower rack 51 located in the lower side of the tub 20 and capable of storing relatively large tableware, the upper rack 52 located in the upper side of the lower rack 51 and capable of storing medium-sized tableware, and the top rack 53 located in the upper side of the tub 20 and capable of storing small tableware and the like. The present invention will be described based on an embodiment of the dishwasher provided with three storage parts 50 as illustrated, but not limited thereto.

These lower rack 51, upper rack 52 and top rack 53 can each be configured to be pulled out through the open front side of the tub 20.

To this end, on opposite side walls forming the inner circumferential surface of the tub 20, there may be guide rails (not shown), and for example, the guide rails may include upper rails, lower rails, top rails, and the like.

On the bottom of each of these lower rack 51, upper rack 52, and top rack 53 wheels may be provided. By pulling these lower rack 51, upper rack 52 and top rack 53 out through the front side of the tub 20 to the outside, the user can easily store tableware in them, or take out washed tableware from them.

The guide rails 54 may be provided with a fixed guide rails in the form of a simple rails for guiding the withdrawal and insertion of the storage part 50, or with a telescopic guide rails guiding the withdrawal and insertion of the storage part 50 and being capable of increasing the withdrawal distance according to withdrawal of the storage part 50.

Meanwhile, the door 30 has the purpose of opening or closing the open front side of the above-described tub 20.

In the lower side of the front side that is normally open, there is provided a hinge part (not shown) for opening and closing the door 30, and the door 30 is opened by rotating about the hinge part as a rotation shaft.

At the upper inner side of the door 30, a door latch (not shown) may be provided for maintaining the closed state of the door 30, and correspondingly, at the upper side of the tub 20, a door lock device (not shown) may be provided to engage with the door latch.

Furthermore, the door lock device may be provided with a latch sensor as a door position sensor 36 for sensing whether the door 30 is opened or closed.

Herein, to implement the built-in type, a control panel (not shown) for controlling the dishwasher 1 may be provided on the upper side surface of the door 30.

As illustrated, the control panel may be provided with a display visually displaying information about the current operating status of the dishwasher 1 and the like, and an input part including a selection button for inputting a user's selection operation, and a power button for inputting a user's operation for turning the dishwasher on and off. Since the control panel is provided on the upper side surface of the door 30, it is not exposed to the outside when the door 30 is in the closed state.

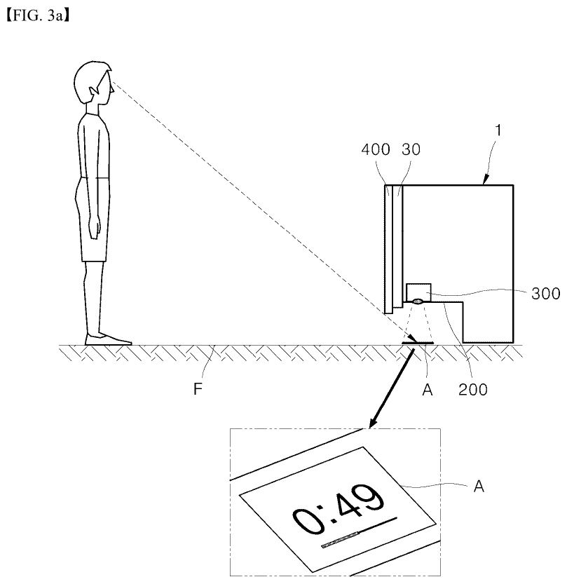

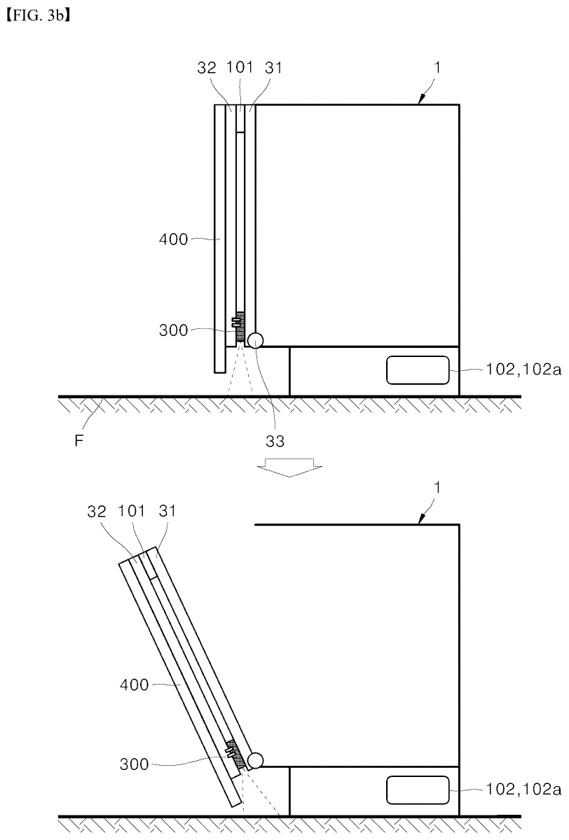

Therefore, as will be described below, an indicator 300 may be provided for visually displaying information about the operating status of the dishwasher 1 when the door 30 is in the closed state. Details regarding the indicator 300 will be described below with reference to FIG. 3A and the following drawings.

Also, as will be described below, a first main circuit board for controlling the control panel including the display may be provided inside the door 30, and furthermore, a first main controller 101 for controlling the overall operation progress of the dishwasher 1 according to user operation input entered through the control panel may be provided on the first main circuit board. The first main controller 101 and the first main circuit board may constitute a portion of the control part 100 controlling the operation of the dishwasher 1.

Meanwhile, the inner surface of the door 30 may form one surface of the tub 20 when the door 30 is closed while, at the same time, forming a seating surface on which the lower rack 51 of the storage part 50 can be supported when the door 30 is fully opened.

To this end, it is preferable that when the door 30 is fully opened, the inner surface of the door 30 forms a horizontal plane in the same direction as the extension of the guide rails 54 by which the lower rack 51 is guided.

Meanwhile, at the bottom of the tub 20, there may be provided a drying air supply part 80 for generating and supplying high-temperature or low-temperature drying air to the washing space inside the tub 20.

As illustrated, by way of example, the drying air supply part 80 may be constructed by including a filter member 883 filtering external air, a blowing fan 825 generating a drying airflow, a heater 84 heating the drying airflow, and an airflow guide 83 disposed at the inside of the tub and guiding the drying airflow.

In the lower surface of the tub 20, there may be provided a drying air supply hole (not shown) through which high-temperature drying air generated in the drying air supply part can be introduced to the inside of the tub 20.

The cover panel 400 may be disposed on and attached to the outer side of the door 30, and may serve to form the front exterior of the dishwasher 1.

In particular, the cover panel 400 may serve to create a sense of unity with surrounding furniture in which the dishwasher 1 is accommodated. To create a sense of unity and consistency with the surrounding furniture in this way, the cover panel 400 may be manufactured to have the same texture and color as the exterior of the surrounding furniture.

The cover panel 400 may be disposed on the front side of the door 30 so as to be relatively movable with respect to the door 30. By way of example, when rotating the door 30 to open the door 30, the cover panel 400 may be moved along the length direction of the door 30. To ensure such relative movement of the cover panel 400, the lower end of the cover panel 400 may be spaced upward by a predetermined distance from the outside floor surface F on which the dishwasher 1 rests.

For such relative movement, a link module (not shown) may be provided which relatively moves the cover panel 400 along the length direction of the door 30.

Meanwhile, the dishwasher 1 according to an embodiment of the present invention may further include a base 90 disposed below the tub 20 and serving to support the tub 20 in the direction of gravity.

The base 90 may also serve to accommodate and support functional modules such as the above-described driving part 40 and drying air supply part 80.

To this end, the inside of the base 90 may be provided with an internal space accommodating the functional modules such as the driving part 40 and the drying air supply part 80, in which the functional modules are disposed.

The base 90 may be manufactured through plastic injection molding to have a somewhat complicated and integrally formed structure for accommodating and supporting multiple functional modules.

Additionally, in the base 90, a second main controller 102 and a second main circuit board 102a may be disposed in the form of a control box, which constitute another portion of the control part 100 controlling the operation of the dishwasher 1.

The second main controller 102 serves to control the operation of the driving unit 40 and the drying air supply part 80 accommodated in the base 90, and to determine whether they are operating normally.

FIG. 1 illustratively shows an embodiment in which the control box with the second main controller 102 and the second main circuit board 102a disposed therein is disposed on the left end surface of the base 90. Although the present invention is not limited to this, hereinafter, description will be made based on an embodiment in which the control box is disposed on the left end surface of the base 90.

The second main controller 102 and the second main circuit board 102a may be configured to be electrically connected to the above-described first main controller 101 and first main circuit board, so that electrical control signals and electrical information are interchanged between each other.

[Arrangement structure and fixing means of indicator] Hereinafter, with reference to FIGS. 3A to 6, the indicator 300 provided in the dishwasher 1 according to one embodiment of the present invention will be described.

As described above, the indicator 300 performs a function of displaying predetermined information regarding the operating status of the dishwasher 1 as a visual image by projecting a visible light beam onto the outside floor surface F on which the dishwasher 1 rests.

In particular, the indicator 300 may be configured to project a visible light beam toward the front space of the skirting board portion formed between the rear surface of the door 30 and the front surface of the base 90 so that a visual image IF is generated on the outside floor surface F.

To this end, as shown in FIG. 3A, the indicator 300 may be attached and fixed to a lower frame 200 extending in a forward and upward direction (U-direction) from the front end surface of the base 90, and covering the lower side of the lower surface 25 of the tub 20.

On the other hand, as shown in FIG. 3B, the indicator 300 may also be configured to be attached and fixed to the door 30.

Referring to FIG. 3B, the door 30 may be constructed by including an inner door 31 and an outer door 32.

The inner door 31 is disposed to face the washing space 21. Therefore, it may also be referred to as a door liner. To the inner door 31 a hinge portion may be coupled, which rotatably supports the door 30 for the opening and closing of the door 30.

The outer door 32 is disposed on an outer surface of the inner door 31, and the cover panel 400 may be coupled to the outer door 32.

Although omitted from FIG. 3B for convenience of explanation, the door 30 may further include a side portion. In this regard, although the side portion of the door 30 is omitted from the drawing, the side portion of the door 30 may be formed such that an extension portion of the inner door 31 is bent toward the outer door 32, or such that an extension portion of the outer door 32 is bent toward the inner door 31.

Further, similarly to the side portion, the bottom surface of the door 30 may be formed such that one of the inner door 31 and the outer door 32 is partially bent, or both of them are each partially bent.

In this case, the bottom surface of the door 30 may be at least partially open toward a downward direction. Also, in the bottom surface of the door 30 an opening may be formed, through which the visible light beam of the indicator 300 can pass.

Meanwhile, between the inner door 31 and the outer door 32 an internal space may be formed.

In this case, the indicator 300 may be configured to be disposed in the internal space between the outer door 32 and the inner door 31.

In the case where the indicator 300 is disposed in the internal space between the outer door 32 and the inner door 31, the indicator 300 may be coupled to and fixed on the outer door 32.

For this coupling and fixing, a slot may be formed in the outer door 32, and the indicator 300 may be hook-coupled or screw-coupled to the slot of the outer door 30.

Alternatively, the indicator 300 may be configured to be coupled and fixed to the rear surface of the inner door 31 in a similar manner.

In addition to the above-described mechanical coupling and attachment means, the indicator 300 may be connected to and fixed on the door 30 by a chemical method such as an adhesive.

In the case where the indicator 300 is disposed in the door 30 as shown in FIG. 3B, the indicator 300 may rotate together in linkage with the rotation angle of the door 30, unlike the configuration shown in FIG. 3A.

Therefore, as the door 30 is opened beyond a predetermined angle range, the visible light beam irradiated by the indicator 300 is gradually oriented toward the inside of the skirting board portion formed under the door 30, and thus it is sure to occur that the user is unable to visually check it.

When the user is hardly able to check in this way, it leads to unnecessary power consumption by the indicator 300, and for this reason, the indicator 300 of the dishwasher 1 according to the present invention may be controlled, as will be described later, to be turned off when the door 30 is opened.

The predetermined angle range of the door 30 in which the indicator 300 is turned off may be 5 degrees or more based on its closed state.

Alternatively, it may be in such a distance range that the user cannot insert his/her finger when the door 30 is opened. For example, the indicator 300 may be controlled to be turned off in such a distance range that the distance between the front end of the upper surface of the dishwasher 1 and the upper end of the inner door 31 is 19 mm or more.

Meanwhile, the indicator 300 may be electrically connected to a control panel provided on the upper side surface of the door 30 through the space between the inner door 31 and the outer door 32.

As described above, the first main circuit board and a first main controller 101 may be disposed in the control panel. The user can control the mode, option, and power of the dishwasher 1 via an input part of the first main controller 101.

Therefore, the indicator 300 may be electrically connected directly to the first main controller 101 through the first main circuit board, or may be electrically connected to the second main circuit board 102 and the second main controller 102a provided in the control box via the first main circuit board.

### Visual Image Displayed by the Indicator

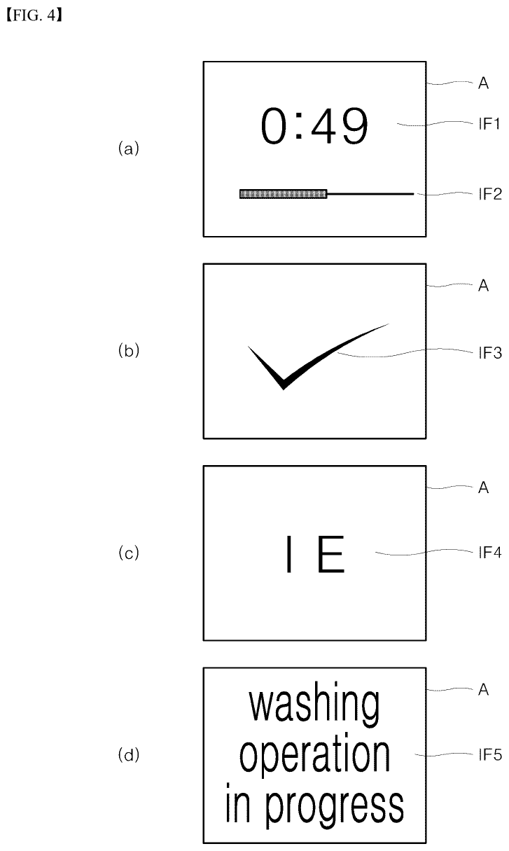

FIGS. 4 to 7 show examples of visual images IF displayed by the indicator 300 of the dishwasher 1 according to one embodiment of the present invention.

As shown, the indicator 300 performs a function of displaying predetermined information regarding the operating status of the dishwasher 1 as a visual image IF by projecting a visible light beam onto the outside floor surface F on which the dishwasher 1 rests.

The user can intuitively check the current operating status of the dishwasher 1 through the visual image IF projected onto the outside floor surface F.

The visual image IF may be image information that is within a display region A onto which a visible light beam is projected, and that can be intuitively recognized by the user.

As shown in FIG. 4, by way of example, the visual image may include: a number image IF1 displaying remaining time information of the currently performed process; a bar image IF2 displaying the progress rate of the currently performed process; a completion image IF3 indicating that a unit process or entire process has been completed; an error image IF4 indicating that a predetermined error has occurred and the process has been stopped; and a letter image IF5 indicating the type of the currently performed process.

It may be configured such that the number image IF1 and the bar image IF2 are displayed together, or displayed separately from each other.

Besides, it may be configured such that the letter image IF5 and the bar image IF2 are displayed together, or, as shown in FIG. 4(d), only the letter image is displayed.

To the error image IF4 an image indicating the type of the occurred error may be further added.

Also, such images are merely examples. As will be described later, the dishwasher 1 according to one embodiment of the present invention may include a communication part to be communicatively connected to an external network. Therefore, the dishwasher 1 may additionally download and store new images different from existing ones from an external server through the communication part.

Therefore, it is also considered possible to be configured such that the user may select and combine desired images from among the previously stored images and the newly stored images according to convenience.

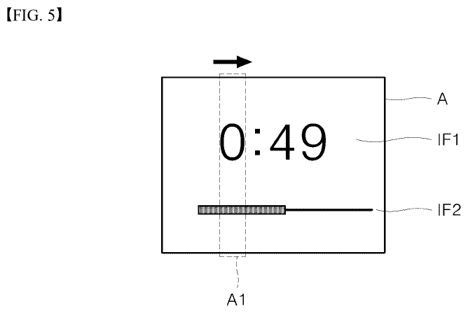

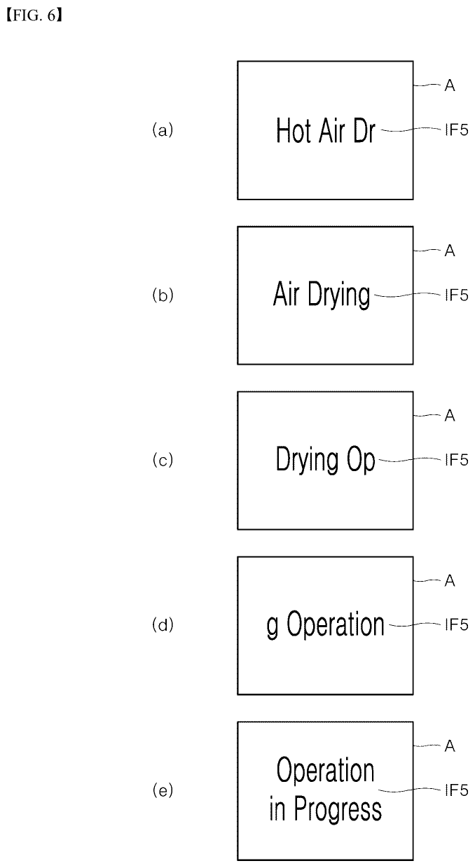

Meanwhile, as shown in FIGS. 5 and 6, animation effects may be added to the visual image IF.

As will be described later, when it is recognized through an optical sensor 37 during the execution of a washing course that the user is present within a predetermined set distance range from the dishwasher 1, a predetermined animation effect may be applied to the visual image IF displayed in the display region A, so that the user can intuitively recognize that the washing course of the dishwasher 1 is currently being validly and normally executed.

First, FIG. 5 shows an example of the animation effect.

Referring to FIG. 5, the animation effect applied to the display region A may include a brightness variation region movement effect, in which a brightness variation region Al is set such that a portion of the display region A has a lower or higher brightness than the remaining region, and the brightness variation region Al is moved in a left-right direction or an up-down direction.

In this regard, the brightness variation region Al may be formed by setting the light transmittance of a partial area of an LCD panel 361, which will be described later, to be lower than that of the remaining areas.

The setting values for the movement speed of the brightness variation region Al and the width of the brightness variation region Al may be adjusted to levels that can enhance visibility for the user.

Meanwhile, FIG. 6 shows another example of the animation effect.

Referring to FIG. 6, when the letter image IF5 is displayed in the display region A, it may include a letter movement effect, in which the letters of a sentence forming the letter image IF5 are moved, in a unit of a letter, in left and right directions at a predetermined time interval, preferably toward the left direction in consideration of the reading order of the sentence.

Here, in consideration of the user's visibility, the predetermined time interval may be 0.3 seconds to 0.6 seconds, and preferably may be 0.5 seconds.

By way of example, FIG. 6 illustrates a situation in which the letter image IF5 saying “Hot Air Drying Operation in Progress” is being displayed in the display region A.

The hot air drying operation may be performed in a manner in which high-temperature drying air is introduced into the washing space 21 through the drying air supply part 80 including a heater 84.

The hot air drying operation may be performed while the door 30 is in a slightly opened state. At this time, a portion of the high-temperature drying air having dried the tableware may escape through the gap created by the slightly opened door 30.

The hot air drying operation may also be performed while the door 30 is in a closed state. In this case, a portion of the high-temperature drying air having dried the tableware may be circulated through a condensation duct, or discharged to the outside through a separate exhaust duct.

The control part 100 may determine and decide that the supply of the high-temperature drying air has started based on the output signal of a temperature sensor (not shown) installed in the drying air supply part 80, and when the control part 100 determines that the hot air drying operation has started, it may control the indicator 300 so that the letter image IF5 saying “Hot Air Drying Operation in Progress” is displayed by the indicator 300, as shown.

In this case, as shown in FIG. 6(a), for animation expression of the letter image IF5 saying “Hot Air Drying Operation in Progress”, “Hot Air Dr” may be displayed in the display region A for the first 0.5 seconds.

Next, as shown in FIG. 6(b), “Air Drying” may be displayed for the next 0.5 seconds, then, as shown in FIG. 6(c), “Drying Op” may be displayed for the next 0.5 seconds, then, as shown in FIG. 6(d), “g Operation” may be displayed for the next 0.5 seconds, and then, as shown in FIG. 6(e), “Operation In Progress” may be displayed for the next 0.5 seconds, so that the user can intuitively recognize the operation status of the washing course of the dishwasher 1 through the animation effect in which the letters appear to flow laterally.

Meanwhile, the animation effects shown in FIGS. 5 and 6 may be set, as will be described later, to be repeated continuously when it is continuously sensed by the optical sensor 37 that the user is present within a predetermined set distance range, and to stop when it is sensed by the optical sensor 37 that the user is present outside of the distance range.

### Overall Configuration of the Indicator

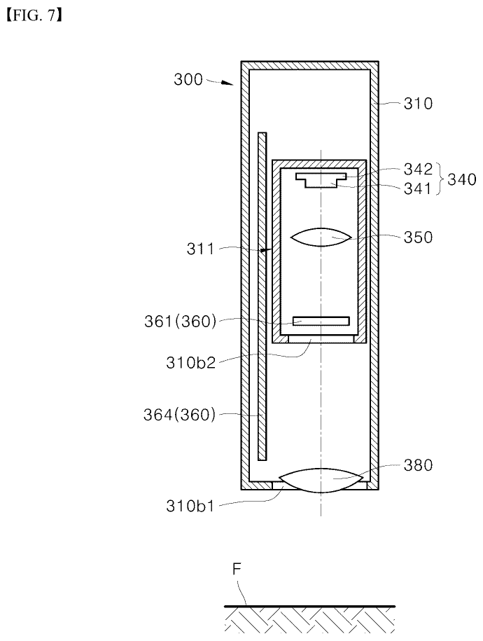

FIG. 7 shows a schematic configuration of the indicator 300 provided in the dishwasher 1 according to one embodiment of the present invention.

Referring to FIG. 7, the indicator 300 may be constructed by including a holder 310 in which an internal accommodation space is formed; a light source module 340 accommodated in the accommodation space of the holder 310 and generating a visible light beam; a first lens 350 refracting the visible light beam generated from the light source module 340; an LCD module 360 partially blocking the visible light beam having passed through the first lens 350 to generate a visual image IF; and a second lens 380 refracting the visible light beam having passed through the LCD module 360.

The holder 310 serves to form the outer body of the indicator 300, accommodate the functional modules constituting the indicator 300 therein, and protect those functional modules.

To this end, the holder 310 may be formed in a box shape with one side open.

Through the open one side of the holder 310, the functional modules of the indicator 300, such as the light source module 340, the first lens 350, the LCD module 360, and the second lens 380, may be inserted into the inside of the holder 310 and be assembled thereto.

In the inside of the holder 310, individual support structures and fixing structures may be formed to be integral with the holder 310 for use with the functional modules such as the light source module 340, the first lens 350, the LCD module 360, and the second lens 380. Particularly, as shown in FIG. 7, in the inside of the holder 310, an auxiliary holder 311 may additionally be provided as means for supporting and fixing the light source module 340, the first lens 350, and the LCD module 360.

In the lower surface of the auxiliary holder 311, a second light-transmitting hole 310b1 may be formed, through which visible light having passed through the first lens 350 and the LCD panel 361 can pass, and which serves to form an outer boundary of the above-described display region A.

The light source module 340 is accommodated in an internal accommodation space of the holder 310, and serves to generate a visible light beam.

The light source module 340 may be constructed by including a light source element 341 generating a visible light beam, and a first circuit board 342 on whose one side the light source element 341 is mounted.

The light source element 341 may, by way of example, be applied as a singular LED element or a plurality of LED elements.

The light source element 341 may be mounted on one side of the first circuit board 342, which faces the first lens 350 and the LCD panel 361, so as to project a visible light beam toward an internal accommodation space of the holder 310.

The first circuit board 342, on which the light source element 341 is mounted, serves to support the light source element 341.

The first lens 350 serves to refract the visible light beam generated from the light source element 341 of the light source module 340.

More specifically, the first lens 350 serves to refract the visible light beam generated and diffused from the light source element 341 so as to travel straight along a horizontal direction.

To this end, the first lens 350 may be disposed and arranged below the light source module 340 to be aligned with respect to the light source module 340.

The LCD module 360 serves to partially block a visible light beam having passed through the first lens 350 to generate a visual image, or to entirely block the visible light beam. Since the LCD module 360 serves to block the visible light beam at least partially in this way, it may also be referred to as a light blocking device.

The LCD module 360 may be constructed by including the LCD panel 361 partially transmitting a visible light beam, and a second circuit board 364 electrically connected to the LCD panel 361 and controlling the operation of the LCD panel 361.

The LCD panel 361 serves to partially block a visible light beam, which has been refracted while passing through the first lens 350, so as to image the predetermined information related to the operation of the dishwasher 1, or serves to entirely block the visible light beam. To this end, the LCD panel 361 may be disposed below the first lens 350 to be aligned to the first lens 350 and the light source module 340, and may be disposed to directly block the path of the visible light beam having passed through the first lens 350.

The second circuit board 364, on which a plurality of circuit elements (not shown) are mounted for controlling the operation of the LCD panel 361, serves to support these circuit elements.

Therefore, as illustrated, in terms of surface area, the second circuit board 364 has the greatest size among the functional modules constituting the indicator 300.

In consideration of such size and surface area of the second circuit board 364, the second circuit board 364 may be configured to be disposed in the inside the holder 310 to be parallel to the length direction of the holder 310 while being separated from the LCD panel 361 and the first circuit board 342.

The first circuit board 342 and the second circuit board 364 may be formed as a single integrated circuit board.

Meanwhile, the second lens 380 serves to refract once again the visible light beam having passed through the second light-transmitting hole 310b2 of the auxiliary holder 311.

To this end, the second lens 380 may be disposed and fixed to a lower end surface of the holder 310 at a position below the auxiliary holder 311.

Below the second lens 380, a first light-transmitting hole 310b1 may be formed to penetrate through the lower end surface of the holder 310.

In this case, the second lens 380 may be disposed in the holder 310 so as to be approximately concentric with the first light-transmitting hole 310b1.

Further, the second lens 380 may be disposed in the holder 310 so as to be at least partially inserted into the inside of the first light-transmitting hole 310b1.

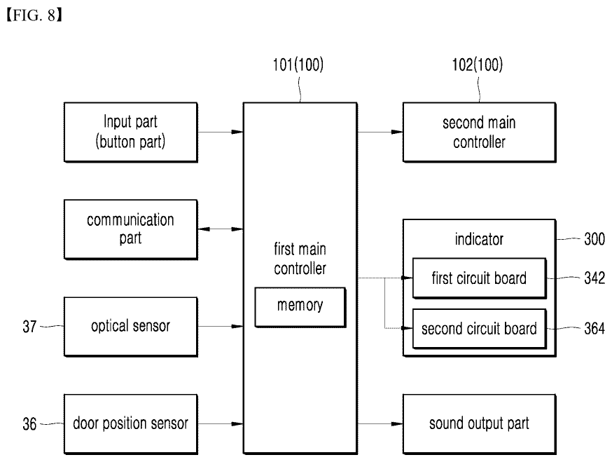

Through this, the visible light beam refracted while passing through the second lens 380 may pass through the first light-transmitting hole 310b1 formed in the holder 310 to be projected toward the outside bottom surface F.

[Configuration of Control Part and Control Method of Dishwasher] Hereinafter, with reference to FIG. 8, the configuration of the control part 100 of the dishwasher 1 according to one embodiment of the present invention will be described.

As shown in FIG. 8, the dishwasher 1 according to an embodiment of the present invention may include the control part 100 for controlling the respective functional components.

The control part 100 may be provided in various forms, such as a microcontroller, a microcomputer, or a microprocessor, as is known in the art.

However, in FIG. 8, there is illustrated an embodiment in which the control part 100 is constructed by including the first main controller 101 disposed in the door 30, and the second main controller 102 disposed in the base 90, as described above.

This is a mere example, and the first main controller 101 and the second main controller 102 may also be provided as a single controller implemented in an integrated manner. Hereinafter, unless otherwise indicated, the control part 100 will be described as a generic concept including the first main controller 101 and the second main controller 102.

First, the control part 100 may be electrically connected to the input part including a selection button by which a user's selection operation is input, and a power button by which a user's operation for turning the power of the dishwasher 1 on and off is input.

Additionally, the control part 100 may be electrically connected to the optical sensor 37 disposed in the door 30. The optical sensor 37 is known in the art as a light sensor or a photo sensor, and performs a function of outputting an electrical signal indicative of a change in light or light quantity.

Furthermore, as means for electrically outputting an electrical signal indicative of a change in light or light quantity, a sensor of an ultrasonic type or a laser type may also be employed. In this case, there may be further provided a transmitting unit transmitting ultrasonic waves or laser, and a receiving unit receiving reflected ultrasonic waves or laser.

Hereinafter, description will be made focusing on an embodiment in which a light sensor or photo sensor is employed as the optical sensor 37, but the present invention is not limited thereto, and a configuration in which a sensor of an ultrasonic type or a laser type is employed is also applicable.

As such, since the optical sensor 37 is configured to sense a change in light or light quantity, it can serve both as a light quantity sensor for sensing ambient illumination around the dishwasher 1 and as a proximity sensor for sensing whether an object or a user approaches the vicinity of the dishwasher 1.

In order to assist in effectively performing the functions as a light quantity sensor and a proximity sensor in this way, the optical sensor 37 may be disposed in a front upper end portion or a front lower end portion of the door 30. Alternatively, the optical sensor 37 may also be configured to be installed at a lower portion of the main body (toe kick portion) of the dishwasher 1.

The control part 100 may receive an output signal of the optical sensor 37, and, based on the received output signal, determine ambient illumination around the dishwasher 1 and whether the user is in proximity to the dishwasher 1.

Additionally, the control part 100 may be, as described above, electrically connected to the door position sensor 36 provided as a latch sensor.

The control part 100 may receive an output signal from the door position sensor 36 and, based on the received output signal, effectively determine whether the door 30 is currently in a closed state or in an opened state.

The control part 100 may, as described later, use whether the door 30 is in a closed state or in an opened state as a criterion for determining whether to operate the indicator.

Additionally, when determining that, after the power button is turned on, the door 30 of the dishwasher 1 is in an opened state, and even after a predetermined second set time has elapsed, the door 30 continues to remain in the open state, the control part 100 may control the display and a sound output part to generate a visual non-operation alarm or an acoustic non-operation alarm including information that the door 30 continues to be in an opened state and information that the operation of the dishwasher 1 is in a stopped state, that is, a non-operation state, through the display or the sound output part.

Meanwhile, the control part 100 is electrically connected to a memory and a timer. The control part 100 calls operation conditions and time conditions for each process, which have been previously stored in the memory, and uses them to generate control signals for controlling the progress and termination of the process.

Moreover, the memory may further store therein information on a first set time serving as a time condition for turning off the indicator after initial power-on, information on a second set time serving as a time condition for generating the above-described non-operation alarm, and information on a third set time serving as a time condition for turning off the indicator 300 after completion of the washing course.

By way of example, the first set time may be within a range between 4 seconds and 6 seconds, and preferably may be 5 seconds. The second set time may be within a range between 2 minutes and 4 minutes, and preferably may be 3 minutes. The third set time may be within a range between 20 seconds and 40 seconds, and preferably may be 30 seconds.

Further, the memory may further store therein information on a time interval of image change for applying an animation effect to a visual image IF.

By way of example, the time interval of image change may be 0.3 seconds to 0.6 seconds, and preferably may be 0.5 seconds.

Besides, the memory may store therein information on a reference illumination serving as a criterion for adjusting illumination of a visual image irradiated by the indicator 300 during the progress of a washing course.

By way of example, the reference illumination may be within a rage between 40 lux and 60 lux, and preferably may be 50 lux.

Besides, the memory may store therein information on a set distance range serving as a condition for applying an animation effect to a visual image generated through the indicator 300 during the progress of a washing course.

The predetermined set distance range from the optical sensor 37 may mean a straight-line distance from the optical sensor to the outside floor surface. Particularly, it may mean a straight-line distance from the optical sensor 37 to a kitchen floor surface on which a user's feet are positioned.

By way of example, the set distance range may be a distance of 0.9 meters or more and 1.1 meters or less, and preferably may be 1 meter. That is, in the case where the distance range is set to 0.9 meters, an object can be sensed when it is within 0 to 0.9 meters. In the case where the distance range is set to 1 meter, an object can be sensed when it is within 0 to 1 meter.

The distance of 0.9 meters or more and 1.1 meters or less, to which the set distance range is limited in this way, has been selected in consideration of a distance range in which a user can operate the dishwasher 1 by stretching his/her arm and a suitable distance based on the user's eyesight.

Additionally, the controller 100 may calculate the elapsed time for each process using the timer, and compare it with the pre-stored time condition for each process to determine whether each process has been completed. As will be described later, the respective processes may include a pre-washing process, a washing process, a rinsing process, a heating and rinsing process, and a drying process.

In particular, as described above, elapsed time after initial power-on, elapsed time after door opening determination, elapsed time after washing course completion, and the like may be further calculated through the timer.

Further, the control part 100 is electrically connected to the display and the sound output part.

The control part 100 may visually display, through the display, information regarding the operation state, operation time, and process completion or non-completion of the dishwasher 1, and may control the above-described sound output part, such as a buzzer or speaker, to output, in a voice or sound form, an alarm regarding the operation state or process completion of the dishwasher 1.

Besides, as will be described later, after the power button is turned on, the control part 100 may control the display or the sound output part to output, through the display, a visual alarm including information that the door 30 remains in an opened state and information that the operation of the dishwasher 1 is in a stopped state, that is, a non-operation state, or to output, through the sound output part, a voice/sound alarm including the same information.

Besides, the control part 100 may be electrically connected to a wireless communication part. The control part 100 may be communicatively connected directly to a user terminal through the wireless communication part, or connected indirectly through a repeater or the like. There is no limitation on applicable communication methods, but by way of example, the wireless communication part may be provided as a Wi-Fi module.

The control part 100 may receive, through the wireless communication part, a control signal for operating the dishwasher 1, or may transmit, to a user terminal, information on the operation of the dishwasher 1, information on the progress status of each process, and, as will be described later, after the power button is turned on, information that the door 30 remains in an opened state and information that the operation of the dishwasher 1 is in a stopped state, that is, a non-operation state.

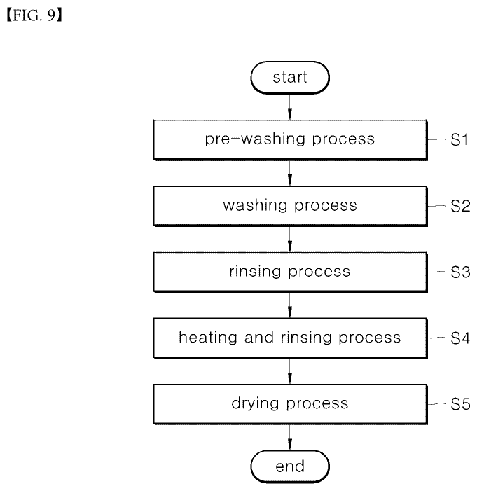

Hereinafter, with reference to FIGS. 9 to 14, a control method S100 of the dishwasher 1 according to one embodiment of the present invention will be described.

As shown in FIG. 9, the control part 100 may, by way of example, generally control the progress of the washing course of the dishwasher 1, which proceeds in the order of a pre-washing process S1, a washing process S2, a rinsing process S3, a heated rinsing process S4, and a drying process S5.

The pre-washing process S1 is a process in which the washing pump 45 is driven to circulate the washing water without injecting detergent through the detergent supply device and the amount of contamination is measured through a turbidity sensor (not shown) provided in the sump 41, and the washing process S2 is a process in which the washing water is circulated while injecting detergent through the detergent supply device to wash the tableware.

The rinsing process S3 and the heating and rinsing process S4 are processes in which rinse agent is injected from the detergent supply device and the washing water is circulated to remove any detergent remaining on the tableware.

When the rinsing process S3 and the heating and rinsing process S4 are in progress, heated washing water is supplied so that the tableware can be heated to a predetermined temperature. Through this, the drying efficiency of tableware can be improved and the drying time can be shortened in the drying process S5 that is performed after the rinsing process S3 and the heating and rinsing process S4 have been completed.

Any one or more of these processes may be adjusted to be omitted or performed two or more times depending on the washing course setting and option.

In this regard, between the respective processes, a drain stage of the washing water used in each process and a water supply stage for supplying new washing water may be included.

Before the pre-washing process S1, a water supply stage may be included.

Between the pre-washing process S1 and the washing process S2, between the washing process S2 and the rinsing process S3, and between the heating and rinsing process S4 and the rinsing process S3, a drain stage and a water supply stage may be performed, and between the heating and rinsing process S4 and the drying process S5, a drain stage may be performed.

The water supply stage may be performed by controlling an aqua stop (not shown) provided in the water supply part 43 to supply washing water to the sump 41 through a water supply flow path, and the drain stage may be performed by controlling the drain part 44 connected to the sump 41 to drain the washing water to the outside of the dishwasher 1 through a drain flow path.

Meanwhile, as described above, the dishwasher 1 according to the present invention has the purpose of minimizing the power consumption, which would occur when the indicator 300 is unnecessarily maintained continuously in the turned-on state, by means of turning on or turning off the indicator 300 when a predetermined condition is satisfied before and during the progress of the washing course.

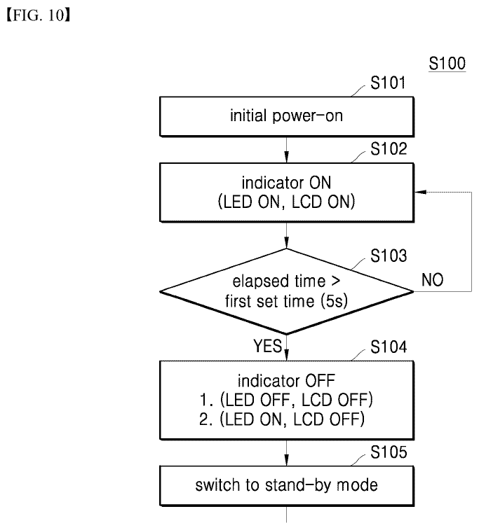

FIG. 10 and the following drawings illustrate processes regarding the turning on and turning off of the indicator 300 before initiation, during progress, and after completion of the washing course of the dishwasher 1.

Meanwhile, the indicator 300 serves to generate the predetermined visual image IF by projecting a visible light beam onto the outside floor surface F.

In this regard, as described above, the visible light beam may be produced by the light source element 341, and the visual image IF may be formed by the LCD panel 361 partially blocking the visible light beam.

Accordingly, when at least one of the light source element 341 and the LCD panel 361 is in the turn-off state, a state in which the visible light beam is not projected onto the outside floor surface F may be formed, and this state may be defined as the turn-off state of the indicator 300.

Thus, the turn-off state of the indicator 300 may include a state in which both the light source element 341 and the LCD panel 361 are turned off, and a state in which the light source element 341 is turned on but the LCD panel 361 is turned off.

Meanwhile, the state of the dishwasher 1 prior to the actual operating state in which the washing course as shown in FIG. 9 is initiated and progressed, may be classified into: a power cut-off state in which connection with an external power supply is separated, an inspection state in which power is applied by the external power supply being connected again for the first time after the power cut-off state, a stand-by mode state after completion of the inspection state, and an operation-ready state formed when the power button is turned on in the stand-by state.

The power cut-off state may be a state in which the plug of the power cable of the dishwasher 1 is completely separated from an electrical outlet corresponding to an external power supply. Because the power supply is completely cut off, the dishwasher 1 becomes a state in which it cannot be operated even when the power button of the input part is pressed.

The inspection state may proceed from the power cut-off state when the plug of the power cable of the dishwasher 1 is first connected to an electrical outlet of the external power supply.

In this way, when the plug of the power cable of the dishwasher 1 is first connected to the electrical outlet of the external power supply, in order to check the wiring connection for each electric component constituting the dishwasher 1, the control part 100 may supply current for a predetermined time to each electrical component to drive each electrical component.

First, FIG. 10 illustrates a process of progressing to the stand-by mode state through the power cut-off state and the inspection state.

Referring to FIG. 10, when the dishwasher 1 in the power cut-off state is reconnected initially to the external power supply and power is supplied to the dishwasher 1, the control part $101 may supply a predetermined current to each electric component to check the wiring connection status and the normal operation status of the electric components. (S101) At this time, the control part 100 also supplies current to the light source element 341 and the LCD panel 361 of the indicator 300, which correspond to electrical components, to turn on the indicator 300. (S102) In this case, since power is supplied for the purpose of checking the wiring connection status and normal operation status of the electrical components, both the light source element 341 and the LCD panel 361 are turned on regardless of whether the door 30 is open or closed, so that the indicator 300 can become the turn-on state.

Next, the control part 100 calculates, by means of the timer, the elapsed time from when the current was supplied to the light source element 341 and the LCD panel 361 of the indicator 300, and compares the elapsed time with the first set time stored in the memory. (S103) Here, the first set time may be within a range between 4 seconds and 6 seconds, and preferably may be 5 seconds.

When, in step S103, when determining that the elapsed time from when the current is supplied to the light source element 341 and the LCD panel 361 has reached the first set time, the control part 100 turns off the indicator 300 to stop the projection of the visible light beam. (S104)

The first set time defined as being between 4 seconds and 6 seconds, and preferably 5 seconds as above has been set in consideration of the time range required for a user to return to the dishwasher 1 after inserting the plug of the dishwasher 1 into an electrical outlet, and visually observe the visible light beam formed on the outside floor surface F. That is, it may be set to any time period equal to or shorter than 6 seconds.

The arbitrarily selected time range may be set longer according to the state in which the dishwasher 1 is installed.

As described above, the projection of the visible light beam can be stopped after effectively informing the user that the dishwasher 1 is in a normal state, so the dishwasher 1 according to one embodiment of the present invention can minimize power consumption compared to that of the related art in which the indicator 300 is continuously turned on.

Meanwhile, as described above, the turning off of the indicator 300, that is, the stopping of projection of the visible light beam, may be achieved by turning off both the light source element 341 and the LCD panel 361, or by turning off the LCD panel 361, causing it to become a light blocking device while the light source element 341 is in a turned-on state.

Thus, without separate turn-off control for the light source element 341, the stopping state of visible light projection can be easily achieved while minimizing power consumption only by the operation of turning off the LCD panel 361.

Next, when the indicator 300 is turned off in step S104, the control part 100 stops the inspection state and switches the state of the dishwasher 1 to the stand-by mode. (S105) That is, the state in which the indicator is off may mean entering the stand-by mode. The state in which step S104 has been completed may mean the stand-by mode state. Alternatively, the state in which, after the initial power-on, the light source element or the LCD is maintained without any further change of state before any separate operation may also be referred to as the stand-by mode.

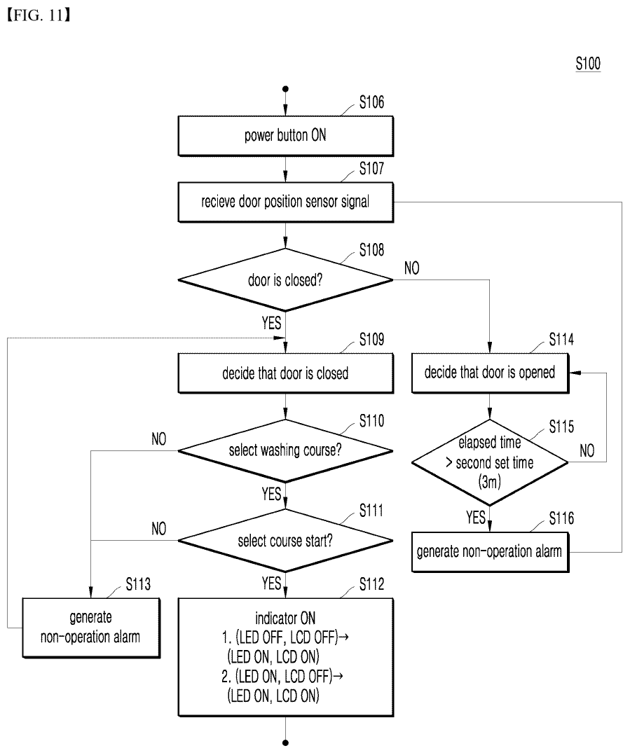

FIG. 11 illustrates a process of transitioning from the stand-by mode state to the operation-ready state.

Referring to FIG. 11, when the power button of the input part is turned on in the stand-by mode state, the control part 100 switches the dishwasher 1 to the operation-ready state. (S106) Next, when in step S106 the dishwasher 1 is switched to the operation-ready state, in order to check whether the dishwasher is in a state capable of proceeding with the washing course, and more specifically to check whether the door 30 is in a closed state, the control part 100 receives an output signal from the door position sensor 36 and determines whether the door 30 is in a closed state or an opened state. (S107, S108) If it is determined in step S108 that the door 30 of the dishwasher 1 is currently in a closed state, the control part 100 makes decision that the door 30 is in a closed state, that is, in a state in which proceeding with the washing course is possible. (S109) When the decision has been made in step S109 that the door 30 is in a closed state, the control part 100 checks whether the user has performed the operation of selecting the washing course and selecting the start of the course through the selection button of the input part. (S110, S111) At this time, if it is determined in steps S110 and S111 that the user has not performed the operation of selecting the washing course or the operation of selecting the start of the course, the control part 100 outputs, through the display or sound output part, a non-operation alarm indicating that the operation of the dishwasher 1 is in a stopped state because the course selection or course start operation has not been performed. (S113) Through this, it is possible to minimize the waiting time for the user's course selection operation and course start operation can be minimized, and it is possible to minimize the power consumption that may occur due to the operation-ready state being maintained for a long time.

Meanwhile, if it is determined in steps S110 and S111 that the user has validly performed the operation of selecting the washing course or the operation of selecting the start of the course, the control part 100 supplies power to the indicator 300 to turn on the indicator 300 which was in the off state. (S112)

At this time, as described above, if both the light source element 341 and the LCD panel 361 were in a turned-off state, current may be supplied to both the light source element 341 and the LCD panel 361 so that the indicator 300 can be turned on.

When the indicator 300 is turned on in step S112, the control part 100 may control the LCD panel 361 so that information corresponding to the washing course selected in step S110 generates the visual image IF.

Alternatively, if only the LCD panel 361 is in the turned-off state in step S104, current may be supplied again only to the LCD panel 361 so that the indicator 300 can be turned on.

Meanwhile, as described above, the information corresponding to the selected washing course may be displayed in various ways such as the number image IF1, the bar image IF2, the letter image IF5, or combinations thereof.

Meanwhile, if it is determined in step S108 that the door 30 of the dishwasher 1 is currently in an opened state, the control part 100 makes decision that the door 30 is in an opened state, that is, in a state in which proceeding with the washing course is not possible. (S114)

When the decision has been made in step S114 that the door 30 is in an opened state, the control part 100 calculates, by means of the timer, the elapsed time from when the decision was made that the door 30 is in an opened state, and compares the elapsed time with a second set time stored in the memory. (S115)

Here, the second set time may be within a range between 2 minutes and 4 minutes, and preferably may be 3 minutes.

The second set time, which has been set to be within a range between 2 minutes and 4 minutes, and preferably 3 minutes, has been selected in consideration of the time for the user to load tableware into the storage part 50 of the dishwasher 1 while the door 30 is in an opened state. Thus, the second set time may be adjusted in consideration of the capacity for tableware or the amount of tableware that can be accommodated in the storage part 50.

Meanwhile, if it is determined in step S115 that the elapsed time has reached the second set time, the control part 100 outputs, through the display or the sound output part, a non-operation alarm indicating that the operation of the dishwasher 1 is in a stopped state because the door 30 is opened. (S116)

Through this, it is possible to minimize the duration of the opened state of the door 30, and it is possible to minimize the power consumption that may occur due to the operation-ready state being maintained for a long time.

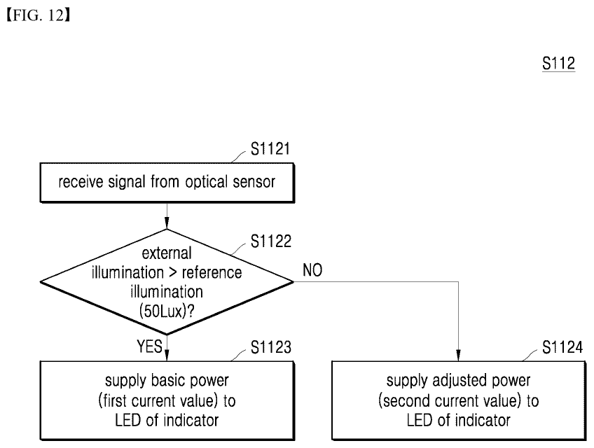

Meanwhile, FIG. 12 illustrates, as sub-steps of step S112, a configuration for adjusting the light amount of the visible light beam output by the indicator 300 based on external illumination.

Referring to FIG. 12, first, the control part 100 receives an output signal from the optical sensor 37 installed on the door 30. (S1121)

After receiving the output signal of the optical sensor 37 in step S1121, the control part 100 compares the external illumination around the dishwasher 1 based on the received output signal with a reference illumination previously stored in the memory. (S1122)

By way of example, the reference illumination may be within a range between 40 lux and 60 lux, and preferably may be 50 lux.

If it is determined in step S1122 that the external illumination is greater than or equal to the reference illumination, the control part 100 continues to supply power having a first current value corresponding to the basic power to the light source element 341 of the indicator 300 so as to maintain the current light amount. (S1123)

On the other hand, if it is determined in step S1122 that the external illumination is less than the reference illumination, the control part 100 supplies an adjusted power having a second current value lower than the first current value to the light source element 341 of the indicator 300 in order to reduce the light amount. (S1123)

Here, the second current value may be within a range from 15% to 25% of the first current value, and preferably may be 20% thereof.

That is, the dishwasher 1 according to one embodiment of the present invention may be controlled to supply power having a value lower than the basic power in the evening or nighttime, when the ambient illumination around the dishwasher 1 is lower than during daytime, and through this, it provides the effect of further reducing the power consumed through the indicator 300.

Meanwhile, when the indicator 300 is turned on in the aforementioned step S112, the control part 100 drives the indicator 300 in a normal mode or a proximity mode.

Here, the driving according to the normal mode means a driving to change the visual image IF displayed by the indicator 300 in response to the progress status of individual processes constituting the washing course, without the aforementioned animation effect.

For example, as shown in FIG. 4, it means a driving to control the LCD panel 361 of the indicator 300 to change the number image IF1 and the bar image IF2 in response to the progress of each process, or to change the letter image IF5 in response to the process progress.

On the other hand, the driving according to the proximity mode means a driving to change the visual image IF by additionally applying the aforementioned animation effect to the driving according to the normal mode.

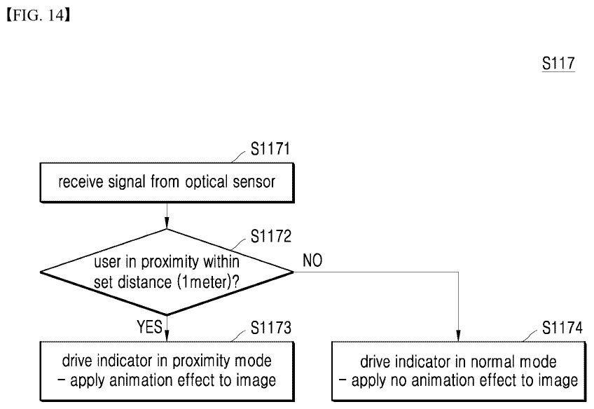

FIG. 14 discloses, as sub-steps of S117, a configuration for making decision on the driving according to the normal mode or the proximity mode.

Referring to FIG. 14, first, the control part 100 receives an output signal from the optical sensor 37 installed on the door 30. (S1171)

After receiving the output signal from the optical sensor 37 in step S1171, the control part 100 determines, based on the received output signal, whether the user is within the set distance range. (S1172)

Here, the set distance range may be a distance of 0.9 meters or more and 1.1 meters or less, and preferably may be 1 meter.

If it is determined in step S1172 that the user is within the set distance range, the control part 100 may control the LCD panel 361 so that the animation effect is applied to the visual image IF generated through the indicator 300 by switching the driving to the proximity mode.

As described above, the animation effect may include the brightness variation region movement effect in which the brightness variation region Al is moved along the left-right direction, and the letter movement effect in which letters are moved in the left-right direction.

When driving in the proximity mode, the control part 100 may control the LCD panel 361 so that at least one of the brightness variation region movement effect and the letter movement effect is reflected in the visual image IF.

Since the indicator 300 is driven in the proximity mode in response to user proximity, the user can intuitively recognize that the washing course of the dishwasher 1 is currently being validly and normally executed, thereby enhancing user convenience.

On the other hand, if it is determined in step S1172 that the user is not within the set distance range, the control part 100 may continue driving the indicator 300 in the normal mode, in which no animation effect is applied, without changing the driving thereof.

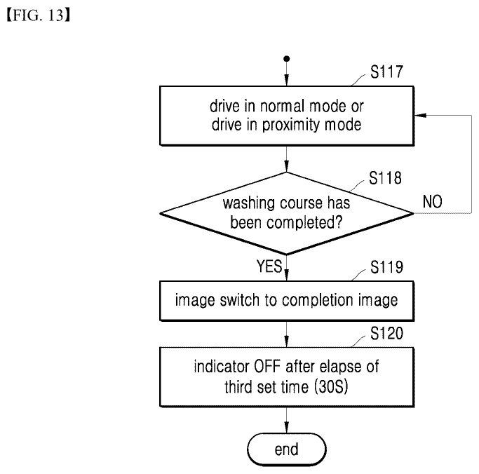

Referring again to FIG. 13, following step S117, it is determined whether the washing course of the dishwasher 1 has been completed. (S118)

If it is determined in step S118 that the washing course has not been completed, the control part 100 may return to the aforementioned step S117 to drive the indicator 300 in the normal mode or the proximity mode.

On the other hand, if it is determined in step S118 that the washing course has been completed, the control part 100 may drive the LCD panel of the indicator 300 so that the completion image IF3 can be displayed through the indicator 300. (S119)

At this time, although not shown, a visual alarm or a sound alarm including information indicating that the washing course has been completed may also be generated through the display or the sound output part.

Through these completion image IF3 of the indicator 300, visual alarm, and sound alarm, the user can easily confirm that the selected washing course has been completed.

Next, after the completion image IF3 is displayed in step S118, the control part 100 turns off the indicator 300 when the third set time has elapsed from after the completion image IF3 has been generated, thereby stopping the display of the visual image IF. (S120)

As described above, the indicator 300 may be turned off by cutting off the power supply to the light source element 341 and the LCD panel 361.

Here, the third set time may be within a range between 20 seconds and 40 seconds, and preferably may be 30 seconds.

In this way, by configuring so that the completion image IF3 can be displayed only for the third set time, power consumption that may occur by displaying the completion image IF3 for an excessively long time can be minimized.

Although the present invention has been described with reference to the drawings as examples, it is obvious that the present invention is not limited to the embodiments and drawings disclosed in this specification, and that various modifications can be made by those skilled in the art without departing from the scope of the technical idea of the present invention. In addition, even if the effects according to the configuration of the present invention were not explicitly written while describing the embodiments of the present invention, it is natural that the effects that can be predicted by the configuration should also be recognized.

1. A dishwasher comprising:
a tub inside which a washing space is formed;
a door opening or closing an open front side of the tub;
an indicator projecting a visible light beam onto an outside floor surface to display predetermined information as a visual image; and
a control part controlling operation of the indicator based on whether the door is in a closed state or an opened state, or based on whether a user is present within a predetermined set distance range from the door.

2. The dishwasher of claim 1, wherein the control part performs a step of making decision on whether to operate the indicator based on whether the door is in a closed state or an opened state.

3. The dishwasher of claim 2, further comprising:
a door position sensor sensing whether the door is in a closed state,
wherein the step of making decision on whether to operate the indicator includes:
a step of receiving an output signal from the door position sensor;
a step of determining, from the output signal received from the door position sensor, whether the door is in a closed state; and
a step of turning on the indicator by supplying power to the indicator when a decision is made that the door is in a closed state in the step of determining whether the door is in a closed state.

4. The dishwasher of claim 3, further comprising:
an input part into which a user's operation for turning power on and off, a user's operation for selecting a washing course, and a user's operation for starting a course are input,
wherein the control part further performs a step of receiving the operation for turning power on, which is input through the input part, before the step of receiving an output signal from the door position sensor.

5. The dishwasher of claim 3, wherein the control part further performs a step of determining whether the operation for selecting a washing course, and the operation for starting a course are input, before the step of turning on the indicator, when a decision is made that the door is in a closed state in the step of determining whether the door is in a closed state.

6. The dishwasher of claim 5, wherein in the step of turning on the indicator, the indicator displays visual information corresponding to the selected washing course.

7. The dishwasher of claim 3, further comprising:
an optical sensor disposed in the door and sensing external illumination,
wherein the step of turning on the indicator includes:
a step of receiving an output signal from the optical sensor;
a step of comparing the external illumination sensed from the output signal received from the optical sensor with a preset reference illumination; and
a step of supplying, to the indicator, an adjusted power lower than a basic power when it is determined that the external illumination is less than the reference illumination.

8. The dishwasher of claim 7, wherein the step of turning on the indicator further includes a step of supplying the basic power to the indicator when it is determined that the external illumination is greater than or equal to the reference illumination.

9. The dishwasher of claim 2, wherein the control part further performs a step of, before the step of making decision on whether to operate the indicator, turning on the indicator regardless of whether the door is in an opened state or in a closed state when power is applied from an external power supply for a first time after connection to an external power supply has been cut off.

10. The dishwasher of claim 9, wherein the control part further performs:
a step of comparing an elapsed time from after the power is first supplied from an external power supply with a predetermined set time; and
a step of turning off the indicator by cutting off the power supplied to the indicator when it is determined that the elapsed time has reached the predetermined set time in the step of comparing an elapsed time with a predetermined set time.

11. The dishwasher of claim 1, wherein the control part performs a step of driving the indicator in a normal mode or in a proximity mode based on whether a user is present within a predetermined set distance range from the door.

12. The dishwasher of claim 11, further comprising:
an optical sensor disposed in the door and sensing whether a user is present within the set distance range,
wherein the step of driving the indicator in a normal mode or in a proximity mode includes:
a step of receiving an output signal from the optical sensor; and
a step of determining, based on the output signal received from the optical sensor, whether a user is present within the set distance range.

13. The dishwasher of claim 11, wherein the driving according to the normal mode is a driving to change the visual image in response to a progress status of a washing course to be progressed in the washing space, and
wherein the driving according to the proximity mode is a driving to change the visual image by additionally applying an animation effect to the driving according to the normal mode.

14. The dishwasher of claim 13, wherein the animation effect includes a brightness variation region movement effect, in which a portion of a display region where the visual image is displayed is set as a brightness variation region so as to have a lower or higher brightness than a remaining region, and the brightness variation region is moved.

15. The dishwasher of claim 13, wherein the visual image includes a letter image, and
wherein the animation effect includes a letter movement effect, in which letters of a sentence forming the letter image are moved in a unit of a letter at a predetermined time interval.
